(19) United States
(12) Patent Application Publication
(10) Pub. No.: US 2012/0139880 A1
(43) Pub. Date: Jun. 7, 2012

(54) INFORMATION PROCESSING APPARATUS ADAPTED TO OPERATION USING A PLURALITY OF OPERATION ELEMENTS, METHOD OF CONTROLLING THE INFORMATION PROCESSING APPARATUS, AND STORAGE MEDIUM

(75) Inventor: Yusuke SHIRAKAWA, Kawasaki-shi (JP)

(73) Assignee: CANON KABUSHIKI KAISHA, Tokyo (JP)

(21) Appl. No.: 13/307,584

(22) Filed: Nov. 30, 2011

(30) Foreign Application Priority Data
Dec. 1, 2010 (JP) 2010-268570(PAT.)

(51) Int. Cl. G06F 3/02

(52) U.S. Cl. 345/184

(57) ABSTRACT

An information processing apparatus capable of discriminating between an operation of turning an operation member and an operation of moving a finger alone and switching between detections of the two operations according to the situation to thereby provide a simple and intuitive user interface. A first detection unit detects a finger movement on a sub electronic dial. A second detection unit detects a turn of the sub electronic dial. When the finger movement has been detected, but the turn of the sub electronic dial has not, a first detection function is executed. When the turn of the sub electronic dial has been detected, a second detection function different from the first detection function is executed without executing the first detection function, irrespective of whether or not the finger movement has been detected.

### BACKGROUND OF THE INVENTION

1. Field of the Invention

The present invention relates to an information processing apparatus, a method of controlling the same, and a storage medium, and more particularly to a technique for improving the operability of a rotary operation member provided in an information processing apparatus.

2. Description of the Related Art

Conventionally, there has been proposed an information processing apparatus, such as a digital camera, an audio player, or a cellular phone, which is provided with a rotary dial as an operation member. The use of the rotary dial enables quick operation for continuous selection and shift between menu options. For example, in a digital camera, the rotary dial is employed as an operation member for making a selection from various kinds of functions, such as a function for setting a shutter speed and a diaphragm value, a function for exposure correction, and a function for frame advance during image reproduction. On the other hand, among information processing apparatuses, a touch sensor e.g. of a resistive film type or a capacitance detection type has been widely used as a simple and intuitive user interface. Therefore, a method has been proposed in which the advantage of the dial-type operation member and that of the touch sensor are combined and a turning operation of a finger is detected using the touch sensor (see e.g. Japanese Patent Laid-Open Publication No. H11-007073). Further, in Japanese Patent Laid-Open Publication No. 2000-357049, there has been proposed a technique in which a single operation member is provided with a multiplex operational function so as to achieve the capability of performing more complicated operations with more ease.

Among various operation members, an operation member that mechanically turns is capable of performing accurate operation for causing one-by-one selection or one-by-one shift e.g. between menu options. On the other hand, a touch sensor is suitable for rough operation, such as selection of a roughly determined area. In order to realize a more simple and intuitive user interface that is capable of directly reflecting a user's intention, it is idealistic that an operation member includes a combination of a detection unit for detecting a mechanical turn of the operation member and a detection unit for detecting a turn of a finger on the operation member.

When the conventional dial-type operation member is used, it is required to dynamically switch between the detection of an operation of turning a dial and the detection of an operation of moving only a finger, according to the situation. However, it is difficult to discriminate between turn of the dial and movement of a finger alone. If such a dial-type operation member is employed in an information processing apparatus equipped with a plurality of functions, there is a fear that simple and intuitive user interface cannot be provided to a user.

### SUMMARY OF THE INVENTION

The present invention provides an information processing apparatus which is capable of discriminating between an operation of turning an operation member and an operation of moving a finger alone and switching between detections of the two operations according to the situation to thereby provide a simple and intuitive user interface, a method of controlling the information processing apparatus, and a storage medium storing a program for implementing the method.

In a first aspect of the present invention, there is provided an information processing apparatus comprising a first detection unit configured to detect a movement of an operation element on a rotary operation member, a second detection unit configured to detect a turn of the operation member, and a control unit configured to control, in a case where the first detection unit has detected the movement of the operation element but the second detection unit has not detected the turn of the operation member, to execute a first function, and in a case where the second detection unit has detected the turn of the operation member, to execute a second function different from the first function without executing the first function, irrespective of whether or not the first detection unit has detected the movement of the operation element.

In a second aspect of the present invention, there is provided a method of controlling an information processing apparatus including a first detection unit configured to detect a movement of an operation element on a rotary operation member and a second detection unit configured to detect a turn of the operation member, comprising detecting the movement of the operation element by the first detection unit, controlling to execute a first function when the turn of the operation member is not detected by the second detection unit, and controlling, in a case where the second detection unit has detected the turn of the operation member, to execute a second function different from the first function without executing the first function, irrespective of whether or not the first detection unit has detected the movement of the operation element.

In a third aspect of the present invention, there is provided a non-transitory computer-readable storage medium storing a computer-executable program for causing a computer to execute a method of controlling an information processing apparatus including a first detection unit configured to detect a movement of an operation element on a rotary operation member and a second detection unit configured to detect a turn of the operation member, wherein the method comprises detecting the movement of the operation element by the first detection unit, controlling to execute a first function when the turn of the operation member is not detected by the second detection unit, and controlling, in a case where the second detection unit has detected the turn of the operation member, to execute a second function different from the first function without executing the first function, irrespective of whether or not the first detection unit has detected the movement of the operation element.

According to the present invention, it is possible to discriminate between an operation of turning the operation member and an operation of moving a finger alone and switch between detections of the two operations according to the situation to thereby provide a simple and intuitive user interface.

Further features of the present invention will become apparent from the following description of exemplary embodiments with reference to the attached drawings.

### BRIEF DESCRIPTION OF THE DRAWINGS

FIG. 1A is a view of the appearance of a digital single-lens reflex camera as an image processing apparatus according to a first embodiment of the present invention.

FIG. 1B is a partial cross-sectional view schematically showing the construction of a sub electronic dial provided on a console section of the digital single-lens reflex camera in FIG. 1A.

FIG. 2 is a schematic block diagram of the digital single-lens reflex camera in FIG. 1A.

FIGS. 3A to 3E are views useful in explaining the internal construction of the sub electronic dial in FIG. 1B.

FIG. 4 is a flowchart of a detection process executed by the camera when an operation of operating the sub electronic dial has been detected.

FIG. 5A is a flowchart of an operation detection process executed using a first detection function in a step of the FIG. 4 process.

FIG. 5B is a flowchart of an operation detection process executed using a second detection function in a step of the FIG. 4 process.

FIG. 6A illustrates examples of screens displayed in a case where still images are displayed on a display section.

FIG. 6B illustrates an example of a screen displayed in a case where a moving image is displayed on the display section.

FIG. 7 is a transverse cross-sectional view showing the internal construction of a rotary shaft portion of a sub electronic dial of a digital single-lens reflex camera as an image processing apparatus according to a second embodiment of the present invention.

### DESCRIPTION OF THE EMBODIMENTS

The present invention will now be described in detail below with reference to the accompanying drawings showing embodiments thereof.

First, a description will be given of a first embodiment of the present invention. An information processing apparatus of the present invention is realized as a digital single-lens reflex camera (hereinafter simply referred to as “the camera”).

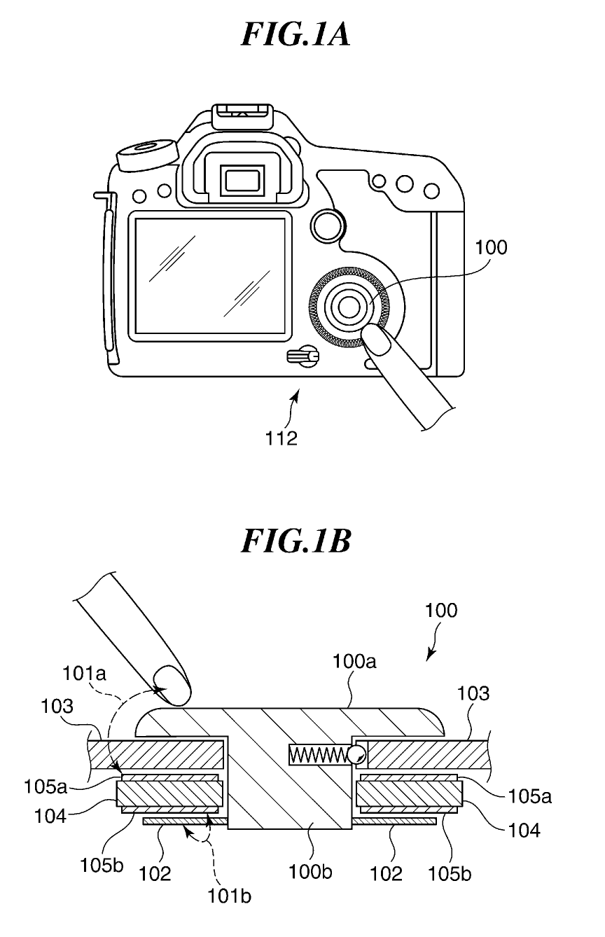

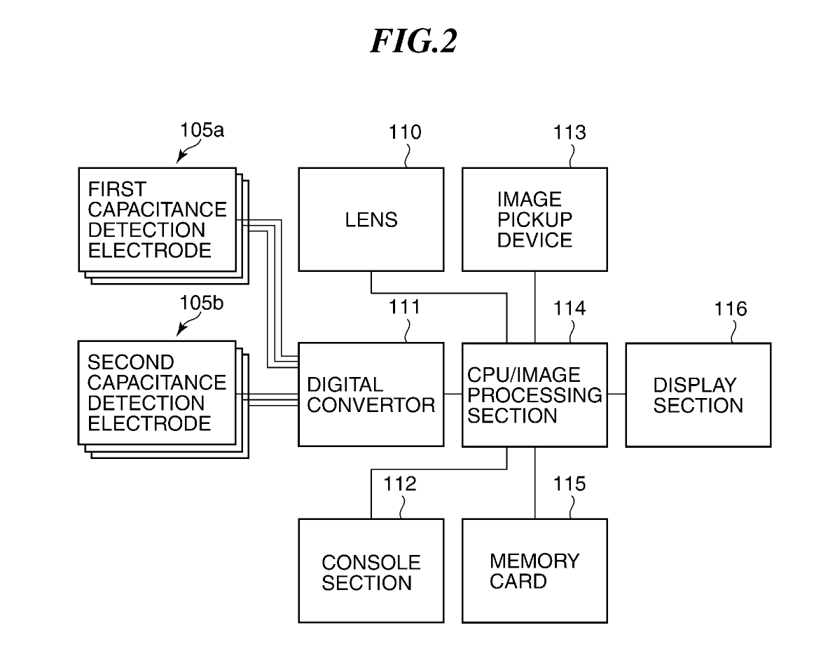

FIG. 1A is a view of the appearance of the digital single-lens reflex camera.

In a console section 112 on the rear surface of the camera shown in FIG. 1A, there is provided a sub electronic dial 100 as a rotary dial-type operation member. The sub electronic dial 100 is used to set various functions of the camera and parameters of the same. Note that an electronic finder, a liquid crystal display, and various buttons, and keys are also arranged on the rear surface of the camera.

FIG. 1B is a partial cross-sectional view schematically showing the construction of the sub electronic dial 100 appearing in FIG. 1A.

The sub electronic dial 100 is formed by a rotary dial portion 100a and a rotary shaft portion 100b. The rotary dial portion 100a is operated by being directly touched by a user's finger. The rotary shaft portion 100b is integrally formed with the rotary dial portion 100a, and from the rotary dial portion 100a, which is disposed outside a camera exterior 103, it extends through the camera exterior 103 into the inside of the camera in a rotatable manner.

A metal plate 102 is rigidly secured to an end of the rotary shaft portion 100b remote from the rotary dial portion 100a. The metal plate 102 turns in unison with the rotary dial portion 100a. A substrate 104 is a printed circuit board on which two types of capacitance detection electrode groups, described hereinafter, are disposed. The substrate 104 is formed as an insulation member. The substrate 104 is fixed to the exterior 103.

On the substrate 104, a first capacitance detection electrode group 105a (one of the above-mentioned two types of capacitance detection electrode groups) is provided on a side facing the exterior 103, and a second capacitance detection electrode group 105b (the other of the above-mentioned two types of capacitance detection electrode groups) is provided on a side facing the metal plate 102. The first capacitance detection electrode group 105a detects a capacitance 101a between the first capacitance detection electrode group 105a and a finger on the sub electronic dial 100. The second capacitance detection electrode group 105b detects a capacitance 101b between the second capacitance detection electrode group 105b and the metal plate 102. The first capacitance detection electrode (first electrodes) 105a and the second capacitance detection electrode (second electrode) 105b are disposed at respective opposite locations back-to-back with the substrate 104 therebetween.

FIG. 2 is a schematic block diagram of the camera in FIG. 1A. Note that component elements of the camera are not limited to the illustrated example.

The first capacitance detection electrode group 105a and the second capacitance detection electrode group 105b are connected to a digital converter 111. The digital converter 111 converts capacitance value data output from each of the first capacitance detection electrode group 105a and the second capacitance detection electrode group 105b to a digital value. The capacitance value data converted to the digital value is delivered to a CPU/image processing section (hereinafter simply referred to as “the CPU”) 114.

The CPU 114 detects an operation of turning the sub electronic dial 100 and an operation of moving a finger based on the input capacitance value data. Further, the CPU 114 performs image processing on image data obtained by shooting performed according to an operation mode set in the camera, control of image display on a display section 116, and so forth. The display section 116 is a small-sized liquid crystal display provided on the rear surface of the camera.

The CPU 114 is connected to a lens 110, the digital converter 111, the console section 112, an image pickup device 113, a memory card 115, and the display section 116. The console section 112 comprises various buttons and keys arranged on the rear surface of the camera. The memory card 115 is a card-shaped storage medium or storage device. The lens 110 is a lens group for use in shooting a moving image or a still image, and includes a focus lens. The image pickup device 113 comprises a CCD (charged coupled device).

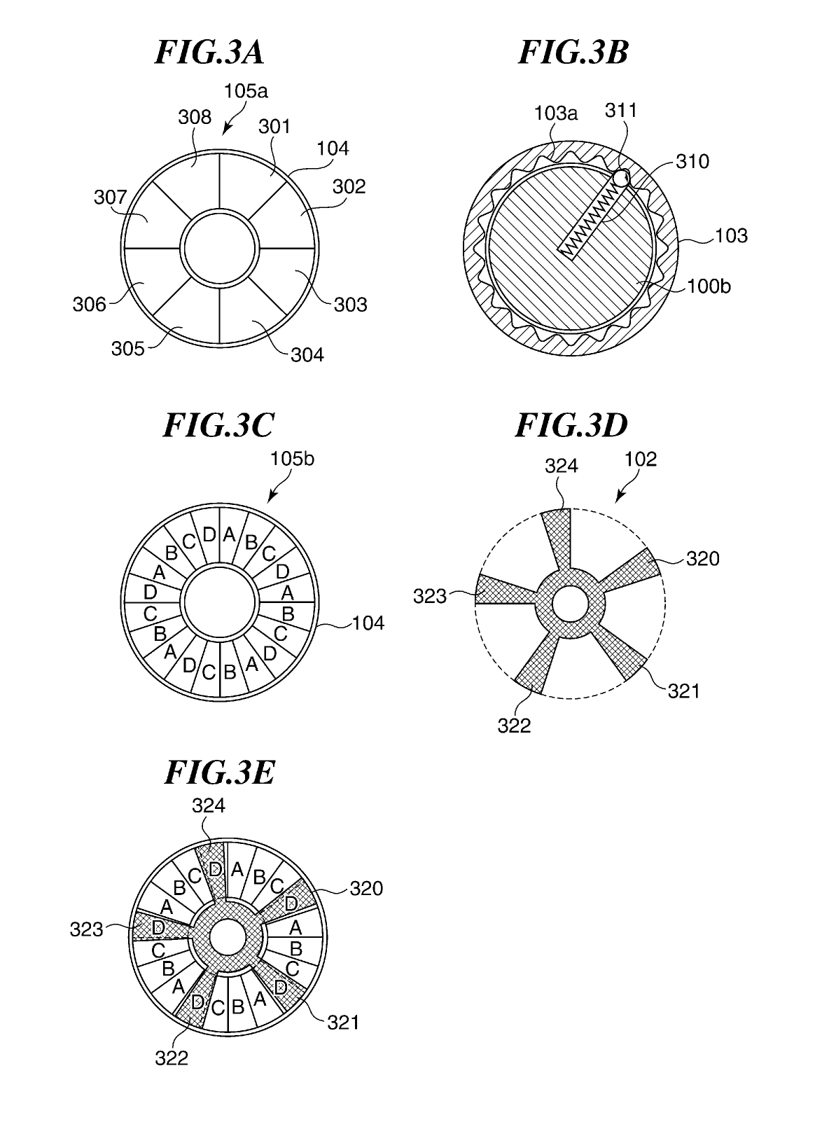

FIGS. 3A to 3E are views useful in explaining the internal construction of the sub electronic dial 100.

FIG. 3A is a front view of the first capacitance detection electrode group 105a.

As shown in FIG. 3A, the first capacitance detection electrode group 105a comprises eight electrodes 301 to 308 each having the same sector shape that extends from the side of the rotary shaft of the sub electronic dial 100. Between each two of the electrodes, there is formed a slit for insulation.

The rotary dial portion 100a is formed of a non-conductive mold material, and therefore when a finger is placed on the rotary dial portion 100a as shown in FIG. 1B, a capacitance is formed between the finger and any of the electrodes 301 to 308. In the camera of the present embodiment, a value of the capacitance is read, whereby it is detected whether or not the finger has been placed on the rotary dial portion 100a. Further, the first capacitance detection electrode group 105a is configured such that a capacitance value can be separately detected from each of the electrodes 301 to 308, so that by comparing the detected capacitance value between the electrodes 301 to 308, it is possible to determine from where to where the finger has been moved. Thus, it is possible to detect a finger movement on the sub electronic dial.

FIG. 3B is a partial transverse cross-sectional view showing the internal construction of the rotary shaft portion 100b of the sub electronic dial 100 and component parts associated therewith.

The rotary shaft portion 100b has a spring 310 and a ball 311 fitted therein such that the ball 311 is pressed against the exterior 103 by the spring 310. The inner peripheral surface of the exterior 103, which faces the rotary shaft portion 100b, is formed with a projection-depression portion 103a. Whenever the rotary shaft portion 100b turns, the ball 311 moves over a projection of the projection-depression portion 103a. With this construction shown in FIG. 3B, when the user turns the sub electronic dial 100, a click feeling is given to the user. For example, in the case of changing a parameter by one level or advancing an image by a single frame, it is possible to perform accurate operation by associating a single click feeling with the one-level change of the parameter or the one-frame advance of the image.

FIG. 3C is a front view of the second capacitance detection electrode group 105b.

As shown in FIG. 3C, the second capacitance detection electrode group 105b comprises a plurality of electrodes each having the same sector shape that extends from the side of the rotary shaft of the sub electronic dial 100. Between each two of the electrodes, there is formed a slit for insulation. The number of the electrodes corresponds to the number (twenty in the present embodiment) of the projections of the projection-depression portion 103a shown in FIG. 3B.

The electrodes of the second capacitance detection electrode group 105b are classified into four types A to D. Electrodes of each of the types A to D are arranged at equal angular intervals. For example, five electrodes A are arranged about the rotary shaft of the rotary shaft portion 100b at angular intervals of 75 degrees.

FIG. 3D is a view of the metal plate 102 as viewed from the front.

As shown in FIG. 3D, the metal plate 102 has a plurality of sector-shaped blades 320 to 324 radially extending from the side of the rotary shaft of the sub electronic dial 100. The blades 320 to 324 have substantially the same shape and substantially the same size (area) as that of the electrodes A to D.

FIG. 3E is a view of the second capacitance detection electrode group 105b in FIG. 3C and the metal plate 102 in FIG. 3D in a state superimposed one upon the other.

The second capacitance detection electrode group 105b and the metal plate 102 are disposed in facing relation to each other such that when a turn of the sub electronic dial 100 is stopped by the projection-depression portion 103a of the exterior 103, the five blades 320 to 324 cover the respective electrodes of one of the types A to D. In the illustrated example, the electrodes D and the blades of the metal plate 102 overlap each other. By reading a value of capacitance formed between the blades 320 to 324 of the metal plate 102 and the electrodes D at this time, it is possible to determine from where to where the sub electronic dial 100 has been turned. More specifically, among the values of the detected capacitances, a capacitance value associated with electrodes covered by the respective blades of the metal plate 102 is highest, and capacitance values associated with the other electrodes are lower, so that it is possible to determine that the sub electronic dial 100 is positioned at the electrodes having the highest capacitance value.

When the capacitance value obtained from between the electrodes of the four types A to D and the five blades of the metal plate 102 changes, it is possible to determine from which to which of the electrodes A to D the sub electronic dial 100 has been moved. More specifically, a comparison is performed between capacitance values before and after a change, whereby it is possible to determine whether the sub electronic dial 100 has been turned clockwise or counterclockwise. For example, if the change in capacitance value indicates a normal direction of A->B->C->D->A, it is determined that the sub electronic dial 100 has been turned clockwise, whereas if the change in capacitance value indicates a reverse direction of D->C->B->A->D, it is determined that the sub electronic dial 100 has been turned counterclockwise.

On the other hand, a case can occur where each of the five blades of the metal plate 102 does not fully cover one of the electrodes A to D, but extends over two of the electrodes A to D. In this case, capacitance values obtained from between the electrodes of the two kinds and the five blades of the metal plate 102 become slightly higher than in the above-described case. For this reason, a predetermined threshold value is provided, and when a detected capacitance value is higher than the threshold value with respect two types of electrodes, it is determined that the sub electronic dial 100 is being turned, i.e. that each of the five blades of the metal plate 102 is currently in such a position that it extends over two electrodes. In this case, therefore, it is not judged that a final turning operation has been performed. By employing this determination method, it is determined that the sub electronic dial 100 has been turned, only when the turning of the rotary shaft portion 100b is stopped by the projection-depression portion 103a of the exterior 103, i.e. when the user turns the sub electronic dial 100 by one click. This makes it possible for the user to recognize one click feeling as a single unit of operation to thereby securely select a menu option or a parameter.

Next, a description will be given of a detection process executed by the camera for detecting an operation performed on the sub electronic dial 100.

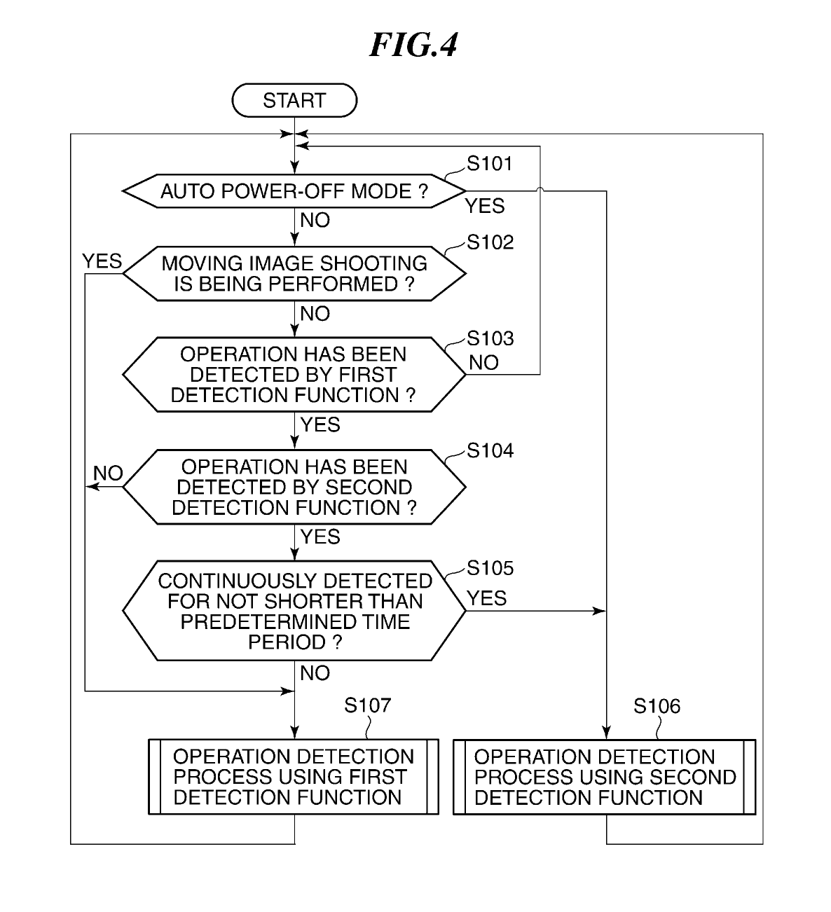

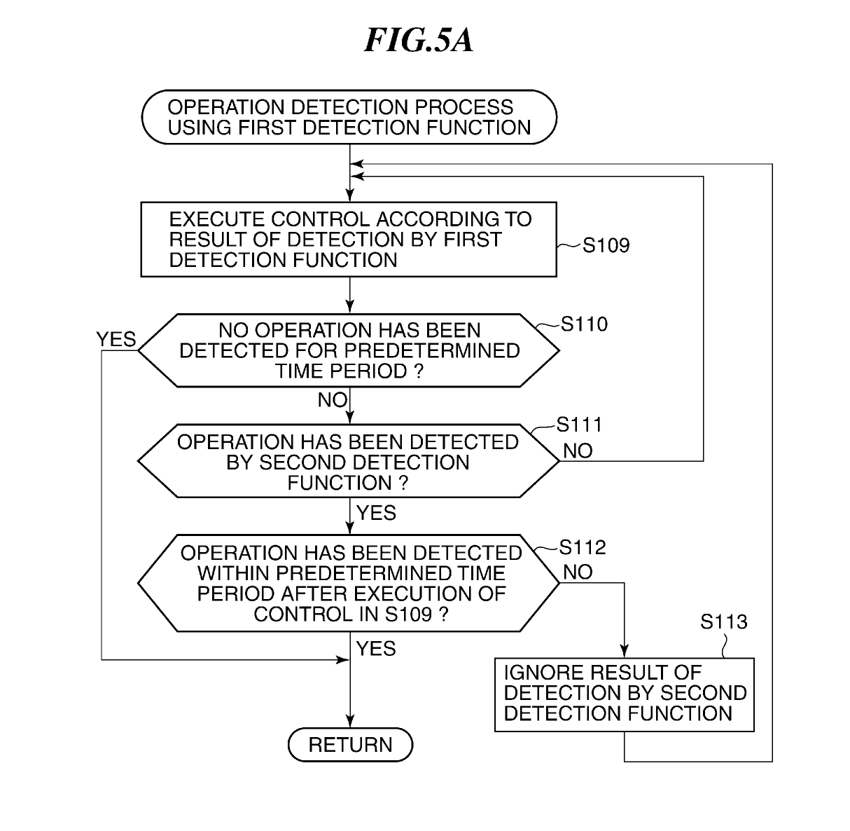

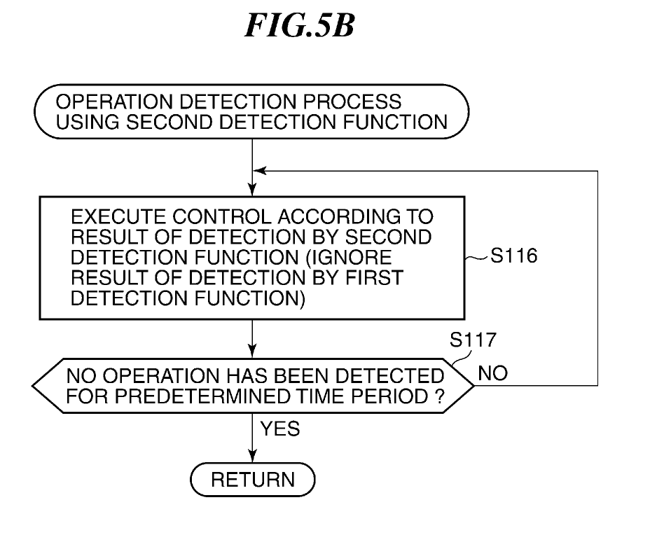

FIGS. 4, 5A, and 5B are flowcharts of the detection process executed by the camera for detecting an operation performed on the sub electronic dial 100. A first detection function described below is provided to detect the aforementioned capacitance 101a to thereby detect a movement of a user's finger on the sub electronic dial 100. On the other hand, a second detection function is provided to detect the aforementioned capacitance 101b to thereby detect a movement of the sub electronic dial 100.

Referring to FIG. 4, the CPU 114 determines in a step S101 whether or not the camera is in an auto power-off mode. If it is determined the camera is not in the auto power-off mode, the CPU 114 proceeds to a step S102, whereas if it is determined the camera is in the auto power-off mode, the CPU 114 proceeds to a detection process (step S106) executed using the second detection function. Now, the detection process executed using the second detection function will be described with reference to FIG. 5B.

The auto power-off mode is an operation mode in which the power of the camera is turned off when the user has not operated the camera over a predetermined time period, thereby reducing consumption of electric power to the minimum to suppress battery consumption. The sub electronic dial 100 is equipped with a switching function for switching between the auto power-off mode and a normal mode according to an operation by the user. If detection of a finger movement by the first detection function is enabled, the camera shifts to the normal mode even in a case where a hand has accidentally approached the sub electronic dial 100, and hence the auto power-off mode cannot attain its object. To avoid this, in the auto power-off mode, operation detection by the first detection function is disabled, and control is performed such that the camera returns to the normal mode only when the sub electronic dial 100 is actually turned.

On the other hand, a user operation of turning the sub electronic dial 100 is substantially the same as an operation for turning around a finger on the sub electronic dial 100, and therefore the operation is detected by both of the first and second detection functions. To solve this problem, in a step S116 in FIG. 5B, the CPU 114 performs control such that detection operation by the first detection function is stopped, or even if the detection operation is performed, control executed according to a result of the detection by the first detection function is ignored by software. Then, the CPU 114 performs control according to a result of detection by the second detection function. Note that for example, during still image reproduction, the control (second function) performed according to a result of detection by the second detection function corresponds to single image-by-single image advance and the control (first function) performed according to a result of detection by the first detection function corresponds to multiple image-by-multiple image advance.

Then, if it is determined in a step S117 that no turn of the sub electronic dial 100 has been detected by the second detection function within a predetermined time period, the CPU 114 judges that no operation has been detected, and the CPU 114 returns to the FIG. 4 detection process.

In the step S102, the CPU 114 determines whether or not the camera is performing moving image shooting. If the CPU 114 determines that the camera is not performing moving image shooting, the CPU 114 proceeds to a step S103, whereas if the CPU 114 determines that the camera is performing moving image shooting, the CPU 114 proceeds to an operation detection process (step S107) executed using the first detection function. The operation detection process executed using the first detection function will be described in detail hereinafter with reference to FIG. 5A.

During moving image shooting, the sub electronic dial 100 is used for parameter setting and menu selection as in a still image shooting mode and a menu operation mode. However, when the sub electronic dial 100 is actually turned, there is caused an inconvenience that a click noise is generated and recorded as a voice noise in a file of a moving image currently being shot. To eliminate this inconvenience, i.e. to enable the user to operate the camera with a feeling of operation similar to that in the still image shooting mode or the menu operation mode while preventing generation of noise, control is performed such that only the finger movement is detected using the first detection function alone.

In FIG. 5A, the CPU 114 executes control according to a result of detection by the first detection function (step S109), and then the CPU 114 proceeds to a step S110.

If it is determined in the step S110 that a next finger movement has not been detected by the first detection function within a predetermined time period, considering that the turn is due to an erroneous operation by the user, the CPU 114 judges that no operation has been detected, i.e. ignores the result of the detection by the second detection function, and then returns to the FIG. 4 detection process. If the moving image shooting is being continued, the steps S102 to S107 are executed again.

If a next finger movement is detected in the step S110, the CPU 114 proceeds to a step S111 to determine whether or not an operation has been detected by the second detection function. If no operation has been detected, the CPU 114 returns to the step S109, whereas if an operation has been detected, the CPU 114 proceeds to a step S112.

In the step S112, the CPU 114 determines whether or not an operation has been detected by the second detection function within a predetermined time period after execution of the control according to a result of detection by the first detection function in the step S109 of the present subroutine. If no operation has been detected within the predetermined time period, the CPU 114 proceeds to a step S113, whereas if an operation has been detected within the predetermined time period, the CPU 114 returns to the FIG. 4 detection process.

In the step S113, the CPU 114 ignores the result of the detection by the second detection function, and the CPU 114 returns to the step S109. When a finger is being moved on the sub electronic dial, the sub electronic dial can be accidentally moved. In consideration of such a case, the CPU 114 executes the steps S112 and S113. Thus, control is performed such that even if a movement of the sub electronic dial 100 is detected within the predetermined time period, the movement is ignored.

Referring again to FIG. 4, the step S103 and the following steps are executed as a detection process to be executed in a case where the camera is not in the auto power-off mode and is not performing moving image shooting, either. In this case, both the first detection function and the second detection function are available. If the CPU 114 detects a finger movement by the first detection function in the step S103 and further detects a turn of the sub electronic dial 100 in a step S104, the CPU 114 proceeds to a step S105.

In the step S105, the CPU 114 determines whether or not the substantially simultaneous detection by the first detection function and the second detection function has continued for not shorter than a predetermined time period. If the substantially simultaneous detection has continued for not shorter than the predetermined time period, it is judged that a turning operation of the sub electronic dial 100 has been detected, so that the CPU 114 proceeds to the step S106 to execute the FIG. 5B operation detection process using the second detection function. On the other hand, if it is determined in the step S105 that a time over which the detections have been continued has not exceeded the predetermined time period, it is judged that a finger movement on the sub electronic dial 100 has been detected, so that the CPU 114 proceeds to the step S107 to execute the FIG. 5A operation detection process executed using the first detection function. Note that the predetermined time period is set e.g. to a time required for turning the sub electronic dial 100 by at least a half click.

If a finger movement is detected by the first detection function in the step S103 and then no turn of the sub electronic dial 100 is detected in the step S104, the CPU 114 proceeds to the step S107 to execute the FIG. 5A operation detection process using the first detection function. Note that when an operation has been detected by the second detection function, an operation should have been detected by the first detection function. Therefore, although in FIG. 4, in the case where the answer to the question of the step S103 is negative (NO), determination as to whether or not an operation has been detected by the second detection function is not performed, also in the case of the answer to the question of the step S103 is negative (NO), determination may be performed as to whether or not an operation has been detected by the second detection function. In this case, when an operation has been detected, the CPU 114 proceeds to the step S106.

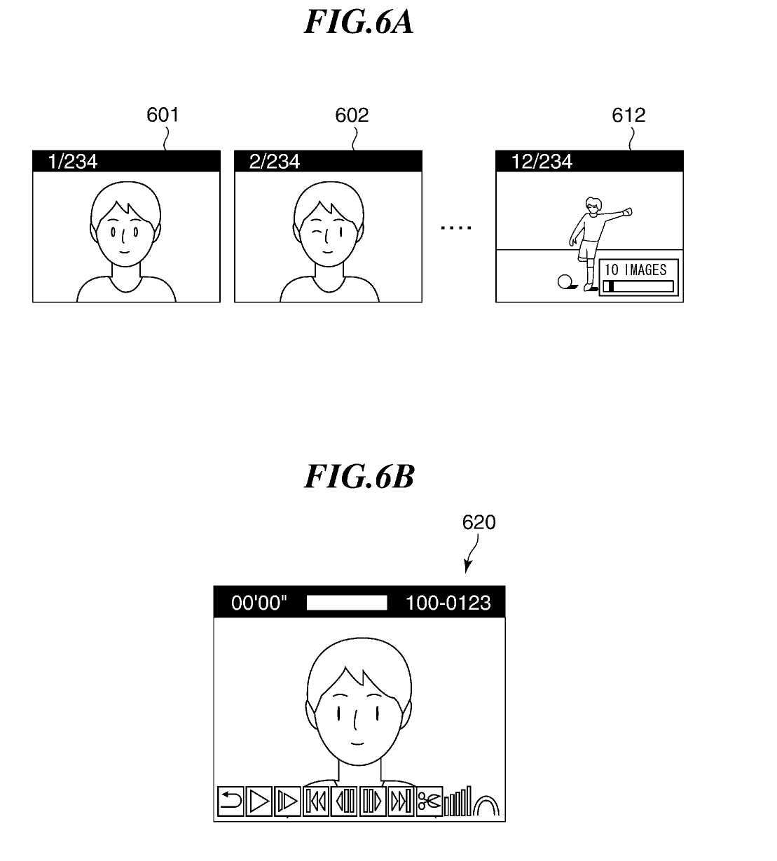

Next, a description will be given, with reference to FIG. 6A, of a case where the above-described control flow is applied to still image reproduction.

FIG. 6A illustrates examples of screens displayed in a case where still images are displayed on the display section 116.

Referring to FIG. 6A, screens 601, 602, . . . , 612 are displayed in a case where a plurality of images (still images) recorded on the memory card 115 are displayed one by one on the display section 116. Numerals in the upper left corner of each of the screen represent the total number of images recorded on the memory card 115 and a number assigned to an image currently displayed on the display section 116. For example, numerals in the screen 601 indicate that there 234 images in the memory card and an image in the screen 601 is a first one of the images.

If the user desires to view a second image from the state of the screen 601, he/she turns the sub electronic dial 100 by one click. That is, the operation detection by the second detection function is performed, whereby the screen 601 is switched to the screen 602. If the user desires to confirm still images stored in the memory card 115 by displaying them one by one, the user turns the sub electronic dial 100 click by click to thereby view the still images while conforming click feelings. In a case where the display is advanced image by image as in the above-described case, more accurate operation can be achieved by the operation detection using the second detection function since click feelings can be confirmed.

On the other hand, the operation method of actually turning the sub electronic dial 100 is not very suitable for use in a case where the user remembers the shooting order of images for the most part. For example, when the user remembers that a desired image is in a 100th or so image of the 234 images, the user needs to click the sub electronic dial 100 ninety-nine times, which is burdensome to the user. To eliminate this inconvenience, the operation method of actually turning the sub electronic dial 100 is switched the operation method of turning a finger around on the sub electronic dial 100. That is, when the operation detection by the first detection function is performed, the CPU 114 displays e.g. the screen 612 on the display section 116.

A character string “10 images” displayed in the lower right corner of the screen 612 indicates that the operation mode is a 10-image advance mode in which the displayed image is advanced in units of 10 images. A bar below the character string represents the position of the currently displayed image in all images of which data is stored in the memory card 115. Since the display is advanced by a unit of ten images from the screen 602, the screen 612 displays a twelfth image.

In a case where no movement of the sub electronic dial 100 has been detected for the predetermined time period after the user turned the finger around on the sub electronic dial 100 in a still image reproduction mode, the display is switched to the screen 612, and the operation mode shifts to the 10-image advance mode. In this operation mode, a control process corresponding to the FIG. 5A operation detection process using the first detection function is executed. This enables the user to operate the sub electronic dial 100 not by actually turning the sub electronic dial 100, but simply by moving a finger on the same, and to perform an operation for advancing the display in units of ten images, so that it is possible to meet the user's demand to view a desired image or an image therearound. Thus, by combining a turn of the sub electronic dial 100 and a finger movement on the same, it is possible to realize a simple and intuitive operation feeling in the still image reproduction mode.

Next, a description will be given, with reference to FIG. 6B, of a case where the above-described control flow is applied to moving image reproduction.

FIG. 6B is a view illustrating an example of a screen 620 displayed in a case where a moving image is displayed on the display section 116.

In moving image reproduction, if a reproduction button (not shown) disposed in the console section 112 is pressed, usually, a moving image file stored in the memory card is reproduced from the beginning of the file to the end of the same. Further, when the user desires to perform frame advance, fast forward, or rewind of the moving image, the user uses the sub electronic dial 100. In this case, turning operations of the sub electronic dial 100 are assigned to a forward frame advance operation and a backward frame advance operation, respectively, and finger movements performed on the sub electronic dial 100 are assigned to a fast forward operation and a rewind operation, respectively.

When the sub electronic dial 100 is turned during moving image reproduction, the camera shifts to a frame advance mode. When the sub electronic dial 100 is turned clockwise, frame advance is performed in the normal direction of the time axis, whereas when the sub electronic dial 100 is turned counterclockwise, frame advance is performed in the reverse direction. If no operation is performed after execution of frame advance, the moving image is stopped in a still image display state after the frame advance, whereas if the reproduction button is pressed again, reproduction of the continued part of the moving image is started from the still image display state. During suspension of moving image reproduction, it is possible to perform an operation for moving image editing, such as cutting or connection.

When a finger is turned around on the sub electronic dial 100 during execution or suspension of moving image reproduction, the camera shifts to a fast forward mode or a rewind mode. If the finger is turned around clockwise, a fast forward operation is performed, whereas if the finger is turned around counterclockwise, a rewind operation is performed. Speed for fast forward or rewind can be adjusted by changing the turning speed of the finger. When the turn of the finger is stopped, the moving image is stopped in the still image display state after the frame advance as in the case of the frame advance mode. In this case as well, it is possible to perform an operation for moving image editing, such as cutting or connection.

As described above, according to the first embodiment, a finger movement on the rotary operation member and a turn of the rotary operation member are detected, and control is performed such that the two detection process can be switched from one to the other, so that it is possible to provide simple and intuitive user interface.

Next, a second embodiment of the present invention is described. The second embodiment of the present invention has the same arrangement as that of the above-described first embodiment shown in FIGS. 1A, 1B, and 2, and therefore component parts and elements identical to those of the first embodiment are denoted by identical reference numerals, and description thereof is omitted. The following description is given of points different from the first embodiment.

In FIG. 5A, when a turn of the sub electronic dial 100 is detected by the second detection function within the predetermined time period after execution of the control according to a result of detection by the first detection function in the step S109, the turn is considered to be due to an erroneous operation by the user, and the result of the detection by the second detection function is ignored in the step S110. However, when the sub electronic dial 100 is turned e.g. during moving image shooting to generate a click noise, the click noise can be recorded as a noise in a moving image file being currently recorded. To solve this problem, in the present embodiment, control is performed mechanically instead of ignoring a result of detection by the second detection function by software as in the first embodiment.

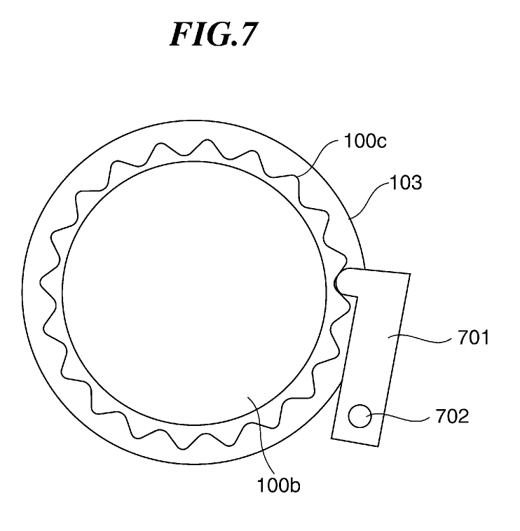

FIG. 7 is a transverse cross-sectional view showing the internal construction of the rotary shaft portion 100b of the sub electronic dial 100 of a digital single-lens reflex camera as an image processing apparatus according to the second embodiment.

The sub electronic dial 100 in the present embodiment has a turn lock mechanism appearing in FIG. 7. The rotary shaft portion 100b has a projection-depression portion 100c formed on an outer peripheral surface thereof which faces an exterior 103. Further, a lock member 701 having a shaft 702 as a pivot is mounted to the exterior 103 in a manner pivotally pressed against the projection-depression portion 100c.

In a case where the camera is set to a predetermined operation mode, the lock mechanism appearing in FIG. 7 is operated to mechanically disable turn of the sub electronic dial 100. For example, when the user presses a moving image shooting button to shift the camera to a moving image shooting mode, the lock mechanism appearing in FIG. 7 is operated to disable turn of the sub electronic dial 100. This makes it possible to realize control for mechanically disabling detection of turn of the sub electronic dial 100.

Even when the turn of the sub electronic dial 100 is disabled, it is possible to detect a finger movement on the sub electronic dial 100, so that an operation for moving image shooting, such as an exposure operation involving setting of a diaphragm value and a shutter speed and a zoom operation can be performed. Further, even if the user attempts to operate the sub electronic dial 100 by force, the sub electronic dial 100 will not turn, and therefore it is possible to prevent generation of a click noise by a turn of the sub electronic dial 100.

Further, the camera may be configured such that whether or not to lock the sub electronic dial 100 can be selectively determined according to a setting by the user before the camera shifts to each operation mode. For example, it can be selected to lock the sub electronic dial 100 in the menu operation mode. This makes it possible to set a function to be operated only by finger movement or a function to be operated by a mechanical dial, according to preference of the user, for example, in a case where the sub electronic dial 100 is designed as an operation unit for operating various functions.

As described above, according to the second embodiment, it is possible to provide an effect of reducing click noise generated when the operation member is turned, in addition to the effects provided by the first embodiment.

Note that control of the CPU 114 may be performed by a single hardware device, or processing of the control may be shared by a plurality of hardware devices, to thereby control the entire apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions. Further, each of the above-described embodiments is given on by way of example, and it is also possible to combine them in a manner as deemed appropriate.

Although in the above-described embodiments, the present invention is applied to a digital camera, this is not limitative, but the present invention is also applicable to a personal computer, a PDA, a cellular phone terminal, a portable image viewer, a printer, a digital photo frame, a music player, a game machine, an electronic book reader, and so forth.

Further, although in the above-described embodiments, it is assumed that a user's finger is used as an operation element for operating the operation member, the operation element is not limited to a user's finger, but anything which enables detection of capacitance may be used as the operation element.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

This application claims priority from Japanese Patent Application No. 2010-268570 filed Dec. 1, 2010, which is hereby incorporated by reference herein in its entirety.

What is claimed is:

1. An information processing apparatus comprising:
a first detection unit configured to detect a movement of an operation element on a rotary operation member;
a second detection unit configured to detect a turn of the operation member; and
a control unit configured to control, in a case where said first detection unit has detected the movement of the operation element but said second detection unit has not detected the turn of the operation member, to execute a first function, and in a case where said second detection unit has detected the turn of the operation member, to execute a second function different from the first function without executing the first function, irrespective of whether or not said first detection unit has detected the movement of the operation element.

2. The information processing apparatus according to claim 1, wherein said control unit controls to disable detection of the movement of the operation element by said first detection unit during when the turn of the operation member is continuously detected by said second detection unit.

3. The information processing apparatus according to claim 1, wherein said control unit controls to execute the second function without executing the first function, in a case where the movement of the operation element and the turn of the operation member have been detected by said first detection unit and said second detection unit, respectively, for not shorter than a predetermined time period.

4. The information processing apparatus according to claim 1, wherein said control unit controls to disable execution of the second function, even when the turn of the operation member is detected by said second detection unit within a first predetermined time period after execution of the first function.

5. The information processing apparatus according to claim 1, wherein said control unit controls to disable execution of the first function, even when the movement of the operation element is detected by said first detection unit within a second predetermined time period after execution of the second function.

6. The information processing apparatus according to claim 1, wherein the information processing apparatus is an image pickup apparatus including an image pickup unit, and
wherein said control unit controls to selectively execute one of the first function and the second function according to an operation mode of the image pickup apparatus.

7. The information processing apparatus according to claim 6, wherein said control unit controls to execute the second function without executing the first function, when the operation mode of the image pickup apparatus is an auto power-off mode.

8. The information processing apparatus according to claim 6, wherein said control unit controls to execute the first function without executing the second function when the image pickup apparatus is performing moving image shooting.

9. The information processing apparatus according to claim 1, wherein said first detection unit includes a first electrode for detecting a capacitance formed between the first electrode and the operation element on the operation member, and detects the capacitance to thereby detect the movement of the operation element on the operation member, and
wherein said second detection unit includes a second electrode for detecting a capacitance formed between the second electrode and a metal plate that turns together with the operation member, and detects the capacitance to thereby detect the turn of the operation member.

10. The information processing apparatus according to claim 9, wherein the first electrode and the second electrode are disposed at respective opposite locations back-to-back with an insulation member therebetween.

11. The information processing apparatus according to claim 1, wherein the operation element includes a user's finger.

12. A method of controlling an information processing apparatus including a first detection unit configured to detect a movement of an operation element on a rotary operation member and a second detection unit configured to detect a turn of the operation member, comprising:
detecting the movement of the operation element by said first detection unit;
controlling to execute a first function when the turn of the operation member is not detected by said second detection unit; and
controlling, in a case where said second detection unit has detected the turn of the operation member, to execute a second function different from the first function without executing the first function, irrespective of whether or not said first detection unit has detected the movement of the operation element.

13. A non-transitory computer-readable storage medium storing a computer-executable program for causing a computer to execute a method of controlling an information processing apparatus including a first detection unit configured to detect a movement of an operation element on a rotary operation member and a second detection unit configured to detect a turn of the operation member,
wherein the method comprises:
detecting the movement of the operation element by said first detection unit;
controlling to execute a first function when the turn of the operation member is not detected by said second detection unit; and
controlling, in a case where said second detection unit has detected the turn of the operation member, to execute a second function different from the first function without executing the first function, irrespective of whether or not said first detection unit has detected the movement of the operation element.
